(19) United States
(12) Patent Application Publication
(10) Pub. No.: US 2023/0305867 A1
(43) Pub. Date: Sep. 28, 2023

(54) LAYERED OPERATING SYSTEM

(71) Applicant: Red Hat, Inc., Raleigh, NC (US)

(72) Inventors: Pierre-Yves Chibon, Paris La Defense (FR); Leigh Griffin, Waterford (IE)

(21) Appl. No.: 17/702,583

(22) Filed: Mar. 23, 2022

(51) Int. Cl. G06F 9/455; G06F 9/54

(52) U.S. Cl. CPC G06F 9/45504; G06F 9/545

(57) ABSTRACT

Systems and methods providing a layered operating system in a device-limited environment. In one implementation, a plurality of functionalities available to a device are identified. The device comprises a base operating system. Each functionality is associated with a corresponding operating system layer. A triggering event associated with a functionality of the plurality of functionalities is detected. Responsive to detecting the triggering event, the operating system layer corresponding to the functionality is added to the base operating system.

### TECHNICAL FIELD

The present disclosure is generally related to operating systems, and more particularly, to layered operating systems in a device-limited environment.

### BACKGROUND

A device's operating system manages the hardware and the software on which it is installed. An operating system can be specifically tailored to a particular device's functionality, thus limiting the uses the device can perform. Alternatively, an operating system can support a variety of functionalities. Generic operating systems can provide services for each of the functionalities supported by the operating system. For devices that can perform a multitude of roles, a generic operating system can be large and inefficient.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a block diagram of an example distributed computing system operating in accordance with one or more aspects of the present disclosure.

FIG. 2 depicts a block diagram of an example computer system operating in accordance with one or more aspects of the present disclosure.

FIG. 3 is a flow diagram of an example method for implementing a layered operating system, in accordance with one or more aspects of the present disclosure.

FIG. 4 depicts a block diagram of an illustrative computer system operating in accordance with one or more aspects of the present disclosure.

### DETAILED DESCRIPTION

Implementations of the disclosure are directed to providing a layered operating system (OS) in a device-limited environment. A device-limited environment is an environment in which the amount of physical space available to house the physical computing device(s) is constrained. In many instances, device-limited environments can include a single computing device used to perform multiple functions. An example of a device-limited environment can be a vehicle, which can include a limited number of physical processing devices to perform multiple functions. For example, a vehicle can have two processing devices, one used to control the functional safety of the vehicle, and the other used to control all other functions of the vehicle (e.g., the global positioning system (GPS), the audio system, the infotainment system, the heating and cooling system, the phone integration system, the voice recognition system, etc.). In order to perform multiple functions, the processing device executes a generic all-encompassing operating system that can support the multiple functionalities. Conventional generic operating systems designed to support all available functionalities may be inefficient in a device-limited environment. As an alternative example, a vehicle's computer system can include functionality-specific processing devices. For example, in addition to a functional safety processing device, the vehicle can include a GPS-specific processing device. The GPS-specific processing device can include a GPS-specific operating system. In such a case, the GPS-specific processing device may be used only to perform GPS-related functions. Thus, the GPS-specific processing device may not be shared by other functionalities, even when the GPS is not being used by the driver.

Another example of a device-limited environment can be the Internet of Things (IoT), in which network-connected physical objects (such as thermostats, appliances, lights in a house, etc.) include embedded processors that can communicate with other devices and/or systems. The space in the physical objects in which to embed a processing device is limited, and thus a single processing device may perform multiple functions. In order to support multiple functions, in some implementations, the operating system installed on the processing device is an all-encompassing generic operating system. Such an all-encompassing generic operating system in a device-limited environment may result in an operating system that is not optimized for any specific functionality, thus resulting in an efficient system.

Aspects of the present disclosure address the above-noted and other deficiencies by implementing a layered operating system (OS) on a device in a device-limited environment. A device-limited environment can include a single device used to perform multiple functions. The layered OS can be built in layers specific to the device's functionalities and/or to the user's customizations. The operating system can include a base standalone OS, which can include the minimum components necessary to operate the device. The minimum components supported by the base OS can include, for example, the kernel, the language stack, a system and service manager used to bootstrap user space and manager user processes, etc.

Additional OS layers can be installed over the base OS. An OS layer is a set of OS components (e.g., drivers, libraries, configuration files, resource usage requests, functionality priority levels, user interface tasks, interrupt protocols, and/or other information specific to the corresponding functionality) that can support a specific functionality. An OS layer can enable the program execution for the corresponding functionality by providing an interface between the functionality and the base OS. A functionality can enable an additional feature provided by the device (e.g., for a computing device operating in a motor vehicle, additional features can include the infotainment system, the phone integration system, the heating and cooling system, etc.). The additional OS layers can be specific to the device, and can be defined by the device manufacturer.

Additionally or alternatively, an OS layer can be specific to the user of the device. The user OS layer can customize the device operation specific to the user, and/or can configure the applications supported by the functionality OS layers installed over the base OS. For example, the end-user OS layer include one or more configuration files used to configure parameters and/or setting specific to the user. Each OS layer (including both functionality layers and user layer) installed over the base OS can utilize the underlying OS layer(s). Furthermore, each OS layer, combined with the base OS, can function as a full operating system.

In embodiments, an OS manager operating on the device can add (i.e., install) and/or remove OS layers to the base OS (and/or to other OS layer(s)). In embodiments, the OS manager can access the OS layers through a centralized distribution service, which can store the OS layers in a registry on a centralized database. The OS manager can send a request, e.g., via a network using an Application Programming Interface (API), to the distribution service, requesting an OS layer. The OS manager can receive the requested OS layer from the distribution service, and install it on the device. The OS layer can be a patch, for example, that includes a set of changes to the base OS to enable the functionality corresponding to the OS layer.

In embodiments, the functionality OS layers and/or user OS layers can be added and/or removed in response to triggering events. A triggering event can be a user request, a usage condition threshold (e.g., conditions related to an increase or decrease in resource usage), an expiration of a specified time period, and/or a detection of another device within a mesh network. It should be appreciated that other triggering events are envisioned. The OS manager can detect a triggering event corresponding to a particular functionality. In response, the OS manager can send a request to the centralized distribution service requesting the OS layer for that particular functionality. The centralized distribution service can transmit the OS layer to the OS manager, which can install the OS layer on the device.

In embodiments, the OS manager can detect a triggering event that triggers the removal of a functionality. The OS manager can uninstall the OS layer corresponding to that functionality. In some embodiments, the OS manager can store the uninstalled OS layer locally on the device for future use, or can delete the OS layer from the device.

Each OS layer can operate independently of the other OS layers, and may not have the ability to modify other OS layers within the operating system. Once the OS layers have been added and/or removed, the full operating system can be installed on the device. In embodiments, the functionality OS layers and/or the end-user OS layers added to the base OS result in an immutable OS that is read-only to the device.

During operation of the device, functionality OS layers can be added or removed, and/or can be prioritized. Prioritizing an OS layer includes adjusting (e.g., increasing or decreasing) the resources (e.g., CPU cycles, RAM, and/or storage space) allocated to the OS layer. The OS layer can have a predetermined priority level. Additionally or alternatively, the OS manager can determine the priority level for each OS layer. In embodiments, the priority level can be based on the amount of time that the one or more processing threads implementing the corresponding functionality has been running, the amount of resources that the one or more processing threads implementing the corresponding functionality has consumed, the predetermined priority level of the functionality, or a combination of the above. The OS manager can determine the priority level of each OS layer installed over to the base OS on a predetermined schedule (e.g., every 2 minutes), and/or upon installing or removing an OS layer to the base OS. Once the OS manager has determined the priority levels for the OS layers installed over the base OS, the OS manager can allocate resources accordingly. For example, the OS manager can allocate a large portion of the available resources to an OS layer with a high priority level, and can allocate a small portion of the available resources to a OS layer with a low priority level.

As noted above, an example of a device-limited environment that includes multiple functionalities can be a motor vehicle (e.g., a passenger car, a truck, etc.). A car can have a limited number of processors and/or devices on which to implement the various functionalities available to the user. The functionalities can include, for example, the audio system, the infotainment system, the global positioning system (GPS), the voice recognition system, the phone integration system, the security system, the cooling and heating system, etc. A triggering event can be detected by the device. For example, the triggering event can be a user request to turn on the audio system, or to turn on or off the air conditioning. Once a triggering event has been detected, the OS layer corresponding to the functionality can be added to the base OS (e.g., by installing a patch retrieved from a centralized OS layer database), or the OS layer corresponding to the functionality can be removed from the base OS (e.g., in response to a user request to turn off the functionality). Furthermore, the user can have a corresponding end-user OS layer that can include customizations specific to that user. The end-user OS layers can be stored in an end-user OS layer registry. Once the user is identified, the corresponding end-user OS layer can be retrieved and installed over the base OS.

In embodiments, the distribution service facilitates the interchange of OS layers. For example, the distribution service can distribute updated version of the OS layers to the devices, e.g., via an Application Programming Interface (API). In some embodiments, a device can be a node in a mesh environment. In such embodiments, the devices can operate in a peer-to-peer manner by interchanging OS layers between them. The devices in the mesh environment can request and/or transmit OS layer(s) to the other devices within the mesh environment. The devices can transmit one OS layer to another device, and/or can transmit a pre-setup of multiple layers to another device. This peer-to-peer interoperability can facilitate debugging of information by exchanging OS layers between devices. For example, a device can transmit an OS layer to another device to determine whether the OS layer has a bug, or whether the device itself is malfunctioning.

Aspects of the present disclosure present advantages, including but not limited to, enabling an operating system that is customized to the current usage of the device on which the OS is operating. By adding OS layers specific to the functionalities associated with triggering events, the overall OS can be customized to the specific usage of the device, thus resulting in a more streamlined and efficient OS. Furthermore, aspects of the present disclosure enable interoperability between OS layers, thus improving performance of the overall OS. Additionally, aspects of the present disclosure enables more efficient debugging by facilitating the interchange of OS layers between devices.

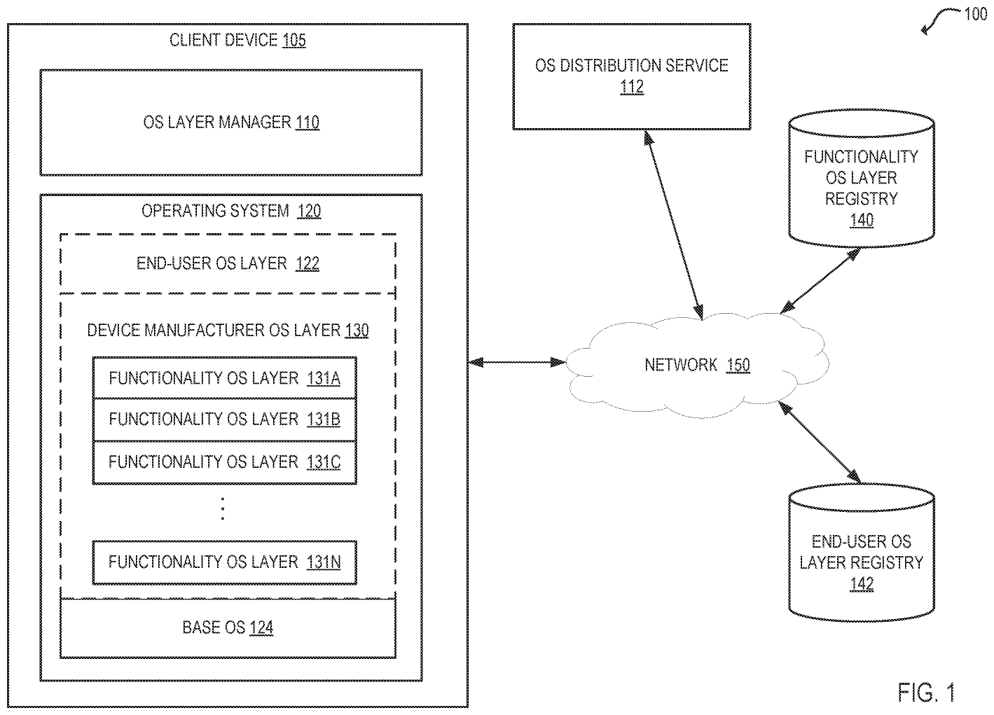

FIG. 1 is a block diagram of a distributed computing system 100, in which embodiments of the present disclosure may operate. One skilled in the art will appreciate that other architectures are possible, and that the implementation of a computer system utilizing examples of the invention are not necessarily limited to the specific architecture depicted by FIG. 1.

The distributed computing system 100 includes a client device 105 connected, via a network 150, to an OS distribution service 112, a functionality OS layer registry 140, and/or an end-user operating system (OS) layer registry 142. The client device 105 can be a computing device in a device-limited environment. The OS distribution service 112 can include one or more computing devices, e.g., server computer systems. In embodiments, the functionality OS layer registry 140 and/or the end-user OS layer registry 142 can be stored on the OS distribution service 112 computing device. Each computing device (e.g., the client device 105 and/or the OS distribution service 112) can include additional resources not pictured in FIG. 1, such as one or more central processing units (CPU), main memory, which may include volatile memory devices (e.g., random access memory (RAM)), non-volatile memory devices (e.g., flash memory) and/or other types of memory devices, a storage device (e.g., one or more magnetic hard disk drives, a Peripheral Component Interconnect (PCI) solid state drive, a Redundant Array of Independent Disks (RAID) system, a network attached storage (NAS) array, etc.), and one or more devices (e.g., a Peripheral Component Interconnect (PCI) device, network interface controller (NIC), a video card, an input/output device, etc.). In certain implementations, the main memory may be non-uniform access (NUMA), such that memory access time depends on the memory location relative to CPU.

In embodiments, the functionality OS layer registry 140 and the end-user OS layer registry 142 can each be a centrally-located database. In embodiments, the functionality OS layer registry 140 can be a database that stores one or more functionality OS layers corresponding to the functionalities available to the client device 105. Each functionality OS layer can include a set of OS components, including but not limited e.g., drivers, libraries, configuration files, resource usage requests, functionality priority levels, user interface tasks, and/or interrupt protocols. The OS layer manager 110 and/or the OS distribution service 112 can access the functionality OS layer registry 140 to retrieve a functionality OS layer corresponding to a requested functionality. The OS layers in the functionality OS layer registry 140 can be defined by the device manufacturer, and can be maintained, for example, by the OS distribution service 112. In embodiments, the OS distribution service 112 can implement updates to the OS layers in the functionality OS layer registry 140, and can distribute updated OS layers in the functionality OS layer registry 140 to client device 105.

In embodiments, the end-user OS layer registry 142 can be a database that stores one or more end-user OS layers. Each end-user OS layer can include a set of OS components, including but not limited e.g., drivers, libraries, configuration files, resource usage requests, functionality priority levels, user interface tasks, and/or interrupt protocols. The OS layer manager 110 and/or the OS distribution service 112 can access the end-user OS layer registry 142 to retrieve a functionality OS layer corresponding to an identified user. In embodiments, upon registering the user with the device manufacturer, for example, the OS distribution service 112 can create an end-user OS layer corresponding to the user stored in end-user OS layer registry 142. The end-user OS layer corresponding to the user can include user-specific customizations (e.g., temperature settings, radio stations presets, volume settings, preferred functionalities, etc.). In embodiments, the end-user OS layers in the end-user OS layer registry 142 can be modified (e.g., updated, deleted) by OS distribution service 112, e.g., in response to a user request.

The OS distribution service 112 can communicate with the client device 105 via an API, or other type of specified interface having operations that OS distribution service 112 can use to transmit OS layers to the client device 105. The OS distribution service 112 can facilitate the distribution of the functionality OS layers stored in functionality OS layer registry 140 and/or end-user layers stored in end-user OS layer registry 142. The OS distribution service 112 can maintain the functionality OS layer registry 140 and/or the end-user OS layer registry 142, including ensuring the OS layers are updated and functional. As further described below, the OS distribution service 112 can receive requests from a client device 105 (via OS layer manager 110), and responsive to the request, can transmit the requested OS layer to the client device 105.

The client device 105 can be a device operating in a device-limited environment. Examples of a device-limited environment include a vehicle, an Internet of things (IOT) object, or a Raspberry Pi device. The client device 105 can be, for example, a processing device installed in a vehicle, a processing device installed in IoT object (e.g., a wearable smart watch, a thermostat, etc.), or a processing device installed in a Raspberry Pi. The network 150 can be a private network (e.g., a local area network (LAN), a wide area network (WAN), intranet, etc.) or a public network (e.g., the Internet). In one example, the network 150 can include a wired or a wireless infrastructure, which can be provided by one or more wireless communications systems, such as a wireless fidelity (WiFi) hotspot connected with the network and/or a wireless carrier system that can be implemented using various data processing equipment, communication towers, etc. The client device 105 can receive data via network 150 using an API, for example.

The client device 105 can include an operating system (OS) layer manager 110 and an operating system 120. The operating system 120 can include a base OS 124, and optionally can include device manufacturer OS layer 130 and/or an end-user OS layer 122. The device manufacturer OS layer 130 can include one or more functionality OS layers 131A-N. The base OS 124 can be a standalone OS and can include the minimum components necessary to operating the client device 105. The OS layer manager 110 can manage the device manufacturer OS layer 130 (including the functionality OS layers 131A-131N) and/or end-user OS layer 122 within operating system 120.

The OS layer manager 110 can add and/or remove functionality OS layers 131A-131N and/or an end-user OS layer 122 in response to detecting a triggering event. Adding a functionality OS layer 131A-131N or an end-user OS layer 122 to OS 120 includes installing the corresponding OS layer over the base OS 124. Removing a functionality OS layer 131A-131N or the end-user OS layer 122 from OS 120 includes uninstalling the corresponding OS layer from base OS 124. In embodiments, uninstalling one or more functionality OS layers 131A-131N and/or the end-user OS layer 122 can include deleting the OS layer data from the device. In some embodiments, rather than deleting the OS layer data from the device, the OS layer manager 110 can store the uninstalled OS layer data locally on the client device 105. The OS layer manager 110 can store the OS layer data locally indefinitely, or can delete the OS layer data if it has not been accessed for a period of time (e.g., for 2 days). Storing the OS layer data locally for a threshold period of time can improve the performance of a functionality that is requested repeatedly over the short amount of time. For example, if a user switches the entertainment system on and off every couple of minutes, the OS layer manager 110 can access the OS layer data associated with the entertainment functionality locally rather than retrieve it repeatedly from the OS distribution service 112 and/or the functionality OS layer registry 140.

In embodiments, the OS layer manager 110 can detect (or otherwise receive a notification of) a triggering event associated with client device 105. The triggering event can be, for example, a user request, a usage condition threshold (e.g., conditions related to an increase or decrease in resource usage), an expiration of a specified time period, and/or a detection of another connected device (e.g., within a mesh network). For example, the usage condition threshold can be a percentage, and the triggering event associated with a functionality can be detected when the resources consumed by the one or more processing threads implementing the functionality increase or decrease by at least the usage condition threshold percentage. For example, the triggering event can be detected when the resources consumed by the processing thread(s) implementing the functionality increase by at least 50%, or decrease by at least 80%. As another example, processing logic can detect a triggering event associated with a functionality when the functionality has been running for an amount of time exceeding a specified time period (e.g., for more than 60 minutes). As another example, processing logic can detect a triggering event associated with a functionality by detecting the presence of a second device (e.g., a smartphone or smart watch connected to the device, e.g., via Bluetooth).

The triggering event can trigger the addition, modification, or removal of a functionality OS layer 131A-131N and/or of an end-user OS layer 122. In embodiments, the OS layer manager 110 can store a list of triggering events and their corresponding functionalities. The OS layer manager 110 can identify, in the list, the functionality corresponding to the detected triggering event. In embodiments, the OS layer manager 110 can send a request to OS distribution service 112, requesting the OS layer corresponding to the identified functionality. The OS layer manager 110 can then add or modify the OS layer received from the OS distributions service 112, according to the triggering event. In some embodiments, the OS layer may be stored locally on client device 105, in which case the OS layer manager 110 can install or modify the OS layer corresponding to the identified functionality. In some embodiments, the triggering event triggers the removal of a functionality, in which the OS layer manager 110 can remove the functionality OS layer 131A-131N corresponding to the identified functionality.

As an illustrative example, the client device 105 can be an IoT thermostat. The OS layer manager 110 can detect (or other receive notification of) a triggering event corresponding to the reporting functionality of the thermostat. The reporting functionality can enable the processing device in the IoT thermostat to send a usage report to a connected device (e.g., to a user's smart phone). The triggering event can be, for example, an expiration of a predefined time threshold (e.g., a predefined period of time has elapsed since the last report was sent), or a detection of a malfunction. The OS layer manager 110 can identify the functionality associated with the triggering event, i.e., the reporting functionality. The OS layer manager 110 can identify the corresponding functionality OS layer from functionality OS layer registry 140. In embodiments, the OS layer manager 110 can request, from OS distribution service 112, the corresponding functionality OS layer. The OS layer manager 110 can receive the functionality OS layer and add it to operating system 120 in device manufacturer OS layer 130.

The functionality OS layers 131A-131N can each have a corresponding priority level. The OS layer manager 110 can determine the priority level of each functionality OS layer 131A-131N. In embodiments, the priority level of the functionality OS layer 131A-131N can be included in the functionality OS layer 131A-N. Additionally or alternatively, the OS layer manager 110 can determine the priority level based on, for example, the amount of time the corresponding functionality has been running, and/or the amount of resources consumed by the corresponding functionality. The OS layer manager 110 can determine the amount of time that a functionality has been running, e.g., by keeping track of the time that the processing thread(s) have spent implementing the functionality. The OS layer manager 110 can determine the priority level for a functionality based on the amount of time that the functionality has been running. For example, if functionality OS layer 131A has been running for a period of time exceeding a threshold period of time, the OS layer manager 110 can determine to decrease the priority level of the functionality OS layer 131A to rebalance the priorities of the functionalities. The OS layer manager 110 can determine the amount of resources consumed by the corresponding functionality by keeping track of the resources consumed by the processing thread(s) implementing the functionality. The OS layer manager 110 can determine the priority level for a functionality based on the amount of resources consumed by the functionality (e.g., by determining the resources consumed by the one or more processing threads implementing the functionality). For example, if the processing thread(s) implementing functionality OS layer 131B has consumed an amount of resources (such as CPU cycles or memory) exceeding a threshold amount of resources, the OS layer manager 110 can determine to decrease the priority level of the functionality.

The OS layer manager 110 can allocate resources (e.g., CPU cycles, RAM, and/or storage space) to the functionality OS layers 131A-131N, e.g., corresponding to each layer's priority level. For example, the OS layer manager 110 can allocate a large amount of resources to a functionality OS layer 131A-131N that has a high priority, and a small amount of resources to a functionality OS layer 131A-131N that has a low priority. The OS layer manager 110 can determine the priority level of functionality OS layers 131A-131N, e.g., on a predetermined schedule and/or upon adding or removing a functionality OS layer 131A-131N. The priority level of the functionality OS layer 131A-131N can be included in the OS layer data stored on functionality OS layer registry 140. In embodiments, the OS layer manager 110 can determine the priority level of each functionality OS layer 131A-131N based on the priority level in the OS layer data and/or based on other factors. The factors can include, for example, a determination of the amount of time and/or resources consumed by the processing thread(s) implementing the functionality corresponding to functionality OS layer 131A-131N.

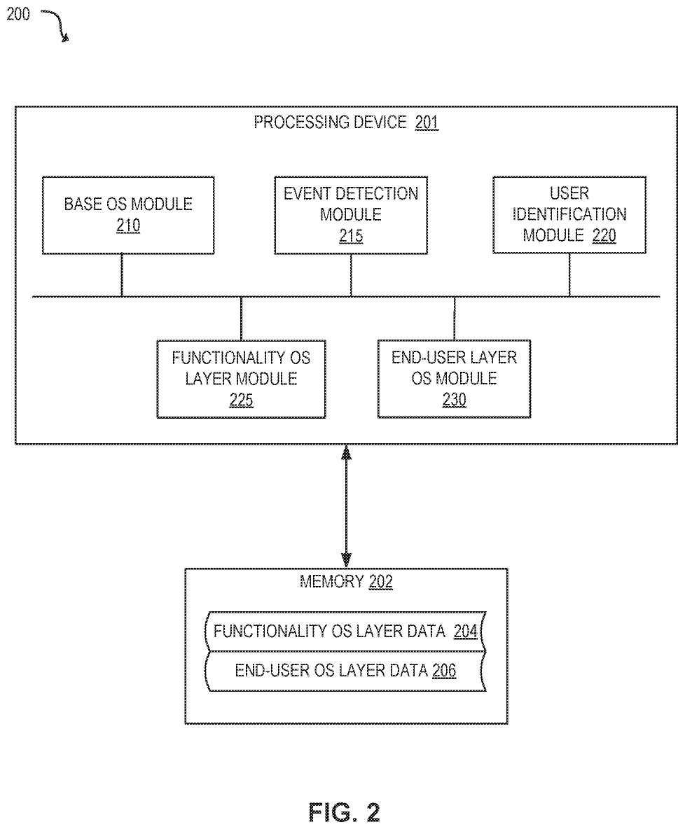

In embodiments, once the OS layer manager 110 has determined the priority levels for at least one of the functionality OS layers 131A-131N, the OS layer manager 110 can prioritize and/or reprioritize the functionality OS layers 131A-131N. Prioritizing and/or reprioritizing the functionality OS layers 131A-131N includes adjusting the resources allocated to the functionality OS layer 131A-131N. The OS layer manager 110 can allocate a higher amount of resources (e.g., CPU cycles, RAM, and/or storage space) to the functionality OS layer(s) 131A-131N that have a high priority level, and can allocate a smaller amount of resources to the functionality OS layer(s) 131A-131N that have a low priority level. In embodiments, the amount of resources allocated to the functionality OS layers 131A-131N can correspond to the priority level of the functionality OS layer. Allocating additional resources to the functionality OS layer that has a higher priority can reduce the latency for the high priority functionality (or functionalities). The prioritization of the functionality OS layers 131A-131N is further described with respect to FIG. 2.

During operating the client device 105, in addition to adding, removing, and/or prioritizing one or more functionality OS layers 131A-131N, the OS 120 can optionally add an end-user OS layer 122. The end-user OS layer 122 can correspond to a user using client device 105, and can be retrieved from end-user OS layer registry 142. In embodiments, the OS layer manager 110 can identify a user using the client device 105, for example using biometrics and/or user input. The OS layer manager 110 can retrieve, from the end-user OS layer registry 142, the end-user OS layer 122 that matches the user identifier. In embodiments, the OS layer manager 110 can request the end-user OS layer matching the user identifier from OS distribution service 112, and the OS distribution service 112 can retrieve the end-user OS layer from end-user OS layer registry 142. In some embodiments, the end-user OS layer matching the identified user can be stored locally on client device 105. The OS layer manager 110 can install the end-user OS layer as end-user OS layer 122.

In embodiments, the OS layer manager 110 can remove the end-user OS layer 122, e.g., in response to a user request, and/or to an expiration of a time period. For example, OS layer manager 110 can receive a request to add an end-user OS layer from a user not associated with end-user OS layer 122. Responsive to such a request, the OS layer manager 110 may remove end-user OS layer 122, request the end-user OS layer associated with the newly received requesting user, and install the newly received end-user OS layer. In embodiments, the user-specific customizations in the end-user OS layer 122 can modify the functionality OS layers 131A-N. As an example, the end-user OS layer 122 can modify the priority levels of the functionality OS layers 131A-131N.

FIG. 2 depicts a block diagram of a computer system 200, operating in accordance with one or more aspects of the present disclosure. Computer system 200 may be the same or similar to client device 105 of FIG. 1. Examples of the client device 105 include, but are not limited to, a processing device installed in a vehicle, a processing device installed in IoT object (e.g., a wearable smart watch, a thermostat, etc.), or a processing device installed in a Raspberry Pi. Computer system 200 may include a base OS module 210, an event detection module 215, a user identification module 220, a functionality OS layer module 225, and/or an end-user OS layer module 230. Computer system 200 can also include a memory 202 that can store functionality OS layer data 204 and end-user OS layer data 206.

In embodiments, the base OS module 210 may enable a processor to boot a computing device (e.g., client device 105 of FIG. 1) using the base operating system provided by an OS provider. The base OS can be a standalone OS that includes the minimum components required to operate the computing device. The base OS can include, for example, the kernel, the language stack, and a system and service manager used to bootstrap user space and manage user processes.

The event detection module 215 can enable a processor to detect triggering events associated with functionalities available to the computing device (e.g., client device 105 of FIG. 1). A triggering event can be a user request, a usage condition threshold (e.g., conditions related to an increase or decrease in resource usage), an expiration of a specified time period, and/or a detection of the presence of another device (e.g., within a mesh network). It should be appreciated that other triggering events are envisioned. A triggering event can trigger the addition of functionality and/or end-user layer, or a triggering event trigger the removal of a functionality and/or end-user layer. For example, the event detection module 215 may receive user input provided via a user interface. The user input can be, for example, an instruction to turn on a functionality (triggering the addition of the corresponding functionality OS layer) or an instruction to turn off a functionality (triggering the removal of the corresponding functionality OS layer).

In some embodiments, the event detection module 215 may detect, as a triggering event, the presence of a correlated second device. For example, the client device 105 can be a processing device installed on a car's computer system, and the presence of a smart phone connected to client device 105 (e.g., via Bluetooth®) can be a triggering event detected by event detection module 215. Such a triggering event may trigger the addition of the end-user OS layer corresponding to the user of the smart phone, for example.

As another example, the event detection module 215 can determine that a functionality OS layer has been added to the base OS for an amount of time exceeding a threshold period of time is a triggering event. As another example, the event detection module 215 detect that a functionality is no longer needed by determining that the processing thread(s) implementing the functionality are no longer consuming resources, or that the amount of resources consumed by the processing thread(s) implementing the functionality has reduced by a predetermined percentage (e.g., by 98%). Such a detection can trigger the removal of the corresponding functionality.

In response to detecting a triggering event, the event detection module 215 can identify a functionality corresponding to the triggering event. In embodiments, the event detection module 215 can access a list of functionalities available to the device. Each functionality in the list can include one or more corresponding triggering events. Each triggering event can specify whether the event triggers the adding or removal of the corresponding function. For example, a triggering event corresponding to the air conditioning function in a car may be a user request. The air conditioning functionality in the list of functionality can be associated with a user request to turn on the air conditioning, which triggers the addition of the functionality, and can be associated with a user request to turn off the air conditioning, which triggers the removal of the functionality. In embodiments, the functionality can be associated with multiple triggering events. For example, the air conditioning can be triggered by a user request as well as by a determination that the temperature in the vehicle has exceeded a threshold value (e.g., a temperature above 80 degrees Fahrenheit can trigger the addition of the air conditioning functionality). In embodiments, the triggering events can be modified by the end-user OS layer. For example, the end-user OS layer can specify that the threshold temperature that triggers the air conditioning is 75 degrees Fahrenheit. Additionally or alternatively, the end-user OS layer can specify additional triggering events associated with functionalities not included in the functionality OS layer. For example, the end-user OS layer can specify that the audio volume is to be reduced responsive to detecting that the speed of the vehicle satisfies a threshold (i.e., the volume is to be reduced if the vehicle is traveling in excess of 65 miles per hour).

For triggering events that trigger the addition of a functionality, the functionality OS layer module 225 can enable a processor to identify, in functionality OS layer data 204, a functionality OS layer associated with the functionality corresponding to the detected triggering event. The functionality OS layer in functionality OS layer data 204 can be a patch that includes a set of changes to the base OS to enable the functionality corresponding to the detected triggering event. The functionality OS layer module 225 can add the identified functionality OS layer(s) to the base OS by installing the patch. In embodiments, the functionality OS layer corresponding to the detected triggering event may be stored locally on the device. In such embodiments, the functionality OS layer module 225 can install the locally-stored functionality OS layer on the device. In embodiments, the functionality OS layer module 225 can compare the locally-stored functionality OS layer to the functionality OS layer stored in functionality OS layer data 204 to determine whether the locally-stored OS layer is up-to-date. If it is not, the functionality OS layer module 225 can update the locally-stored OS layer by retrieving the OS layer from functionality OS layer data 204 prior to installing the OS layer.

For triggering events that trigger the removal of a functionality, the functionality OS layer module 225 can enable a processor to identify a functionality OS layer installed on the device. The functionality OS layer module 225 can uninstall the identified functionality OS layer. In embodiments, uninstalling the functionality OS layer can include deleting the functionality OS layer data from the device. In embodiments, the functionality OS layer module 225 can store the functionality OS layer data locally on the device. The functionality OS layer module 225 can store the OS layer data locally indefinitely, or can delete the OS layer data if it has not been used for a period of time (e.g., for 2 days).

In embodiments, the functionality OS layer module 225 can determine the priority level of each functionality OS layer added to the base OS. The priority level of a functionality OS layer can be included in the functionality OS layer data 204. That is, the functionality OS layer data 204 can include a priority indicator for each functionality OS layer. In embodiments, the priority level can be a number from a predefined range (e.g., an integer between 0 and 10, or a number between 0 and 1). A high priority level can indicate that the corresponding functionality has a high priority.

In embodiments, the functionality OS layer module 225 can determine and/or modify the priority level of a functionality OS layer by determining the amount of time and/or resources consumed by the functionality. For example, if a functionality OS layer has been added to the base OS for a period of time exceeding a threshold period of time, the functionality OS layer module 225 can determine to decrease the priority level of the functionality OS layer to rebalance the priorities of the functionalities. As another example, if a functionality OS layer has consumed an amount of resources exceeding a threshold amount of resources (such as CPU cycles or memory), the functionality OS layer module 225 can determine to decrease the priority level of the functionality OS layer. In some embodiments, the functionality OS layer module 225 can determine the priority level of a functionality OS layer by combining the priority level stored in functionality OS layer data 204 with the amount of time and/or resources consumed by the functionality. For example, if a high priority functionality OS layer has been added to the base OS for a period of time exceeding a threshold period of time, the functionality OS layer module 225 can determine to decrease the priority level of the functionality OS layer. As another example, if two functionality OS layers have the same priority level, the functionality OS layer module 225 can determine to prioritize the functionality OS layer that has consumed fewer resources and/or has been added to the base OS for a lesser amount of time.

As another example, the functionality OS layer module 225 can determine that the amount of resources used by the functionality corresponding to a particular functionality OS layer has decreased by an amount exceeding a threshold (e.g., by more than 80%). As a result, the functionality OS layer module 225 can reduce the priority level associated with the functionality OS layer. As an illustrative example, a functionality available on a car can be a streaming service. The streaming service functionality can use a large amount of resources at launch time. Once the streaming service has been running for a period of time, the amount of resources used by the streaming service can reduce by a certain amount. For example, to start a movie on the streaming service can use a lot of resources to load and buffer the video, however once the movie is running, the amount of resources used is reduced. The functionality OS layer module 225 can determine to reduce the priority level of streaming service functionality OS layer once the amount of resources consumed by the streaming service has reduced by a threshold amount.

In embodiments, the functionality OS layer module 225 can determine the priority level of each functionality OS layer added to the base OS on a predetermined schedule (e.g., every 3 minutes), and/or in response to adding and/or removing an OS layer. Responsive to determining the priority level of each functionality OS layer, the functionality OS layer module 225 can prioritize (and/or reprioritize) the functionality OS layers according to the determined priority levels of the functionality OS layers added to the base OS. Prioritizing (and reprioritizing) the functionality OS layers can include, for example, adjusting the resources allocated to each functionality OS layer. The functionality OS layer module 225 can determine to allocate a higher amount of resources (e.g., CPU cycles, RAM, and/or storage space) to the functionality OS layer(s) that have a high priority level, and to allocate a smaller amount of resources to the functionality OS layer(s) that have a low priority level. In embodiments, the amount of resources allocated to each functionality OS layer can correspond to the priority level of the functionality OS layer. Allocating additional resources to the functionality OS layer that has a higher priority can reduce the latency for the high priority functionality (or functionalities).

The user identification module 220 can enable a processor to identify a user using the client device 105. The user identification module 220 can enable a radio-frequency identification (RFID) receiver that can detect the presence of an RFID tag. A user using the client device can have an RFID tag that can be read by the RFID receiver of the user identification module 220. For example, the RFID tag can be embedded in the user's car key fob. The user identification module 220 can receive the digital data transmitted from the RFID tag, and use the digital data to identify the user. As another example, the user identification module 220 can enable a processor to detect the presence of a user's smartphone via Bluetooth. The user identification module 220 can receive data from the smartphone used to identify the user. As yet another example, the user identification module 220 can enable a processor to identify a user via a fingerprint reader installed on the device, or the user may manually log in to the device. Other user identification methods may be used by the user identification module 220. The user identification module 220 can store the user's identification data in memory 202. The user's identification data can include a user's name, or can include a user reference number.

The end-user OS layer module 230 can enable a processor to identify, in end-user OS layer data 206, an end-user OS layer associated with the user identified by user identification module 220. For example, each end-user OS layer stored in end-user OS layer data 206 can include a reference number corresponding to the identified user. The end-user OS layer module 230 can add the identified end-user OS layer to the base OS.

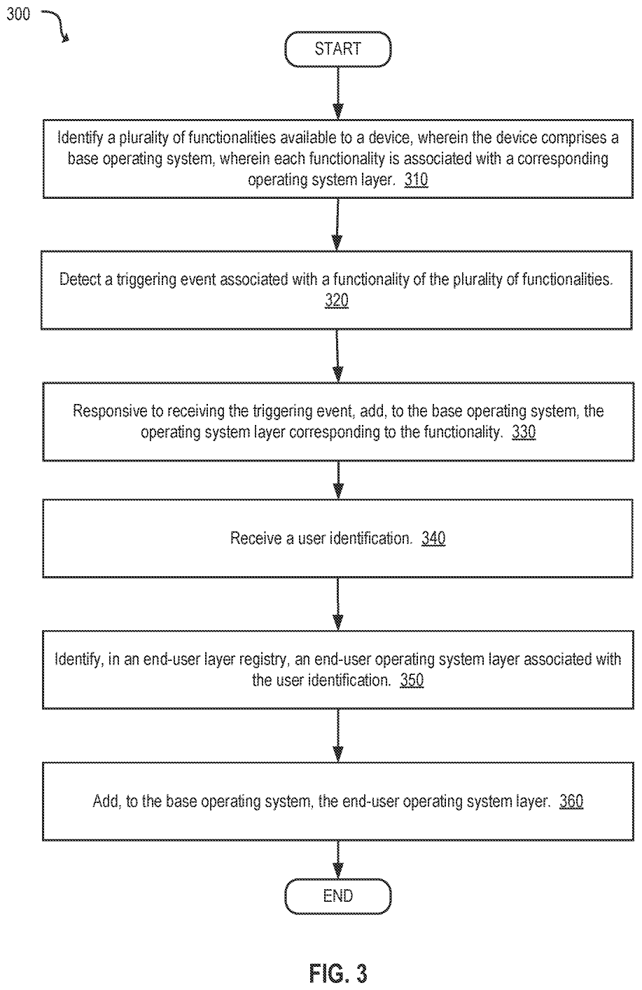

FIG. 3 depicts a flow diagram of an example method 300 for implementing a layered operating system, in accordance with one or more aspects of the present disclosure. Method 300 may be performed by processing logic (e.g., in client device 105 of FIG. 1) that may comprise hardware (e.g., circuitry, dedicated logic, programmable logic, microcode, etc.), software (such as instructions run on a processing device), firmware, or a combination thereof. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). In one embodiment, method 300 may be performed by OS layer manager 110 of FIG. 1.

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 310, processing logic can identify a plurality of functionalities available to a device. In embodiments, the device manufacturer can provide access to a database that includes a list of functionalities. The processing logic can access the database through an API, for example. The list of functionalities can include indicators indicating whether each functionality is available to the device. Processing logic can identify the functionalities that are available to the device based on the indicators. In some embodiments, the device manufacturer can store a list of the functionalities available to the device on the device itself. For example, if the device is a processing device installed in a car, the car manufacturer can provide functionalities for the audio system, the infotainment system, the global positioning system (GPS), the voice recognition system, the phone call system, the security system, the cooling and heating system, etc.

In embodiments, each functionality can have a corresponding operating system layer. The operating system layers can be stored in a functionality OS layer registry, to which the device has access (e.g., via a network). In embodiments, the functionality OS layer registry can be provided by the device manufacturer. The operating system layers can be easily updated and distributed via the registry. The registry can be a database that stores an operating system layer corresponding to a functionality. An operating system layer can enable the functionality to be executed on the device, and can include configuration files, resource requests, priority levels, user interface tasks, interrupt protocols, and/or other information specific to the corresponding functionality.

The device can include a base operating system. The base operating system can include the minimum components necessary to operate the device. The base operating system can be a standalone operating system provided by an OS provider, and can include, for example, the kernel, the language stack, a system and service manager used to bootstrap user space and manager user processes, etc.

At block 320, processing logic can detect a triggering event associated with a functionality of the plurality of functionalities. In embodiments, the triggering event can be a user initiated request, such as a user selecting one of the functionalities via a user interface. For example, if the device is a car, the triggering event can be received from a user turning on the air conditioning. In embodiments, the triggering event can be a usage condition threshold (e.g., conditions related to an increase or decrease in resource usage), an expiration of a specified time period, and/or a detection of another device within a mesh network. For example, the usage condition threshold can be a percentage, and the triggering event associated with a functionality can be detected when the resources consumed by the one or more processing threads implementing the functionality increase or decrease by at least the usage condition threshold percentage. For example, the triggering event can be detected when the resources consumed by the processing thread(s) implementing the functionality increase by at least 50%, or decrease by at least 80%. As another example, processing logic can detect a triggering event associated with a functionality when the processing thread(s) implementing the functionality has been executing for an amount of time exceeding a specified time period (e.g., for more than 60 minutes). As another example, processing logic can detect a triggering event associated with a functionality by detecting the presence of a second device (e.g., a smartphone or smart watch connected to the device, e.g., via Bluetooth).

At block 330, responsive to receiving the triggering event, processing logic can add, to the base operating system, the operating system layer corresponding to the functionality. Processing logic can add the OS layer corresponding to the functionality by installing the OS layer over the base OS. Processing logic can identify, in a functionality OS layer registry, an operating system layer corresponding to the functionality. The functionality OS layer registry can be a database that stores an OS layer corresponding to each of the plurality of functionalities available to the device. Processing logic can identify the OS layer that matches the functionality corresponding to the detected triggering event, and can install the identified OS layer to the base OS. For example, responsive to receiving user input to turn on the air conditioning, processing logic can add the operating system layer corresponding to the air conditioning functionality to the base operating system.

At block 340, processing logic can receive a user identifier. In embodiments, processing logic can detect the presence of a radio-frequency identification (RFID) tag, and can receive data from the RFID tag identifying the user. As another example, processing logic can detect the present of a second device that can be used to identify the user. For example, the second device can be a smart phone, and processing logic can detect the presence of the user's smart phone connected to the device, e.g., via Bluetooth. Processing logic can receive, from the second device, data identifying the user. As another example, processing logic can receive user identification data via biometrics, such as a fingerprint reader installed on the device. Other user identification processes can be used.

At block 350, processing logic can identify, in an end-user OS layer registry, an end-user operating system layer associated with the user identifier. The end-user OS layer registry can be a database that stores OS layers corresponding to users. For example, a user can provide identification information to the device manufacturer, and the device manufacturer can create and store an end-user OS layer specific to the user in the end-user OS layer registry. The end-user operating system layer can include one or more configuration files associated with the user identifier. The one or more configuration files can include parameters and/or settings specific to the identified user. For example, if the device is a car, the end-user operating system layer specific to the identified user can include customizations, such as the user's favorite radio stations, GPS preferences (e.g., whether the user prefers to avoid highway tolls), default heating and cooling settings, etc. At block 360, processing logic can then add the end-user operating system layer to the base operating system.

In embodiments, the additional operating system layers can be prioritized. Processing logic can add additional operating system layers corresponding to additional functionalities. In embodiments, processing logic can detect another triggering event that is associated with a second functionality. Processing logic can identify (e.g., in the OS layer registry) the OS layer corresponding to second functionality, and can add the OS layer corresponding to second functionality to the base OS. Processing logic can determine a priority level for each operating system layer added to the base operating system layer. The priority levels can be determined based on predetermined data (e.g., each functionality can have preset priority level defined by the device manufacturer in the OS layer registry), and/or can be determined based on an amount of time and/or resources the functionality is consuming. For example, the device manufacturer can define that the heating and cooling functionality takes priority over the audio functionality. As another example, processing logic can determine that the amount of resources (e.g., CPU cycles, and/or RAM) consumed by the infotainment functionality is less than the amount of resources consumed by the other functionalities, and as a result can determine that the infotainment functionality operating system has a lower priority level.

Responsive to determining that the priority level of the second functionality exceeds the priority level of the first functionality, processing logic can prioritize the second operating system layer associated with the second functionality over the operating system layer associated with the first functionality. Prioritizing the second operating system layer can include allocating additional resources (such as CPU cycles, RAM, and/or storage space) to the second operating system layer. Prioritizing the second operating system layer can result in improving the performance and/or reducing the latency of the second functionality.

In embodiments, responsive to determining that the functionality is no longer needed, processing logic can remove the operating system layer corresponding to the functionality. In embodiments, processing logic can determine that a functionality is no longer needed by determining that processing thread(s) implementing the functionality is no longer consuming resources, or that the amount of resources consumed by the processing thread(s) implementing the functionality has reduced by a predetermined percentage (e.g., by 98%). In embodiments, processing logic can determine that a functionality is no longer needed responsive to detecting a triggering event, such as user input. For example, processing logic can determine that the air conditioning is no longer being used (e.g., by detecting user input associating with turning off the air conditioning, or by determining that the temperature has reached the desired temperature), and as a result can remove the operating system layer corresponding to the air conditioning from the device.

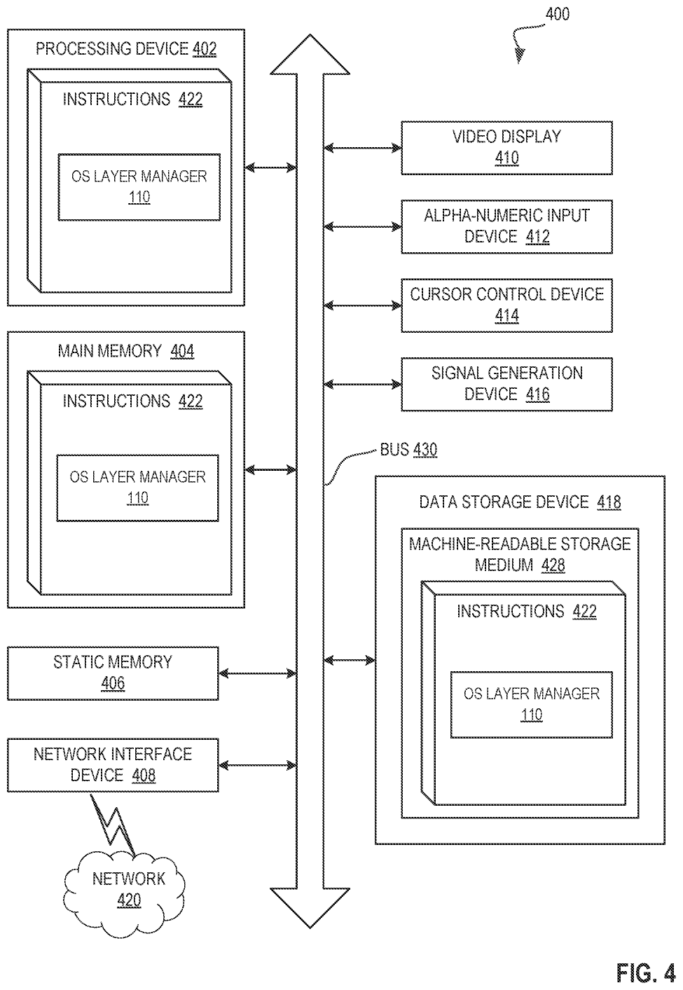

FIG. 4 is a diagrammatic representation of a machine in the exemplary form of a computer system 400 within which a set of instructions for causing the machine to perform any one or more of the methodologies discussed herein may be executed. In various illustrative examples, computer system 400 may correspond to client device 105 of FIG. 1 and/or computer system 200 of FIG. 2. Computer system 400 may be included within a data center that supports virtualization. Virtualization within a data center results in a physical system being virtualized using virtual machines to consolidate the data center infrastructure and increase operational efficiencies. A VM may be a program-based emulation of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain embodiments, computer system 400 may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. Computer system 400 may be provided by a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that device. Further, while only a single machine is illustrated, the term “computer” shall also be taken to include any collection of computers that individually or jointly execute a set (or multiple sets) of instructions to perform any one or more of the methodologies discussed herein.

The example computer system 400 may include a processing device 402, a main memory 404 (e.g., read-only memory (ROM), flash memory, dynamic random access memory (DRAM) (such as synchronous DRAM (SDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets. Processing device 402 may also be one or more special-purpose processing devices such as an application specific integrated circuit (ASIC), a field programmable gate array (FPGA), a digital signal processor (DSP), network processor, or the like. Processing device 402 may be configured to execute OS layer manager 110 for programming the operations and steps discussed herein.

Computer system 400 may further include a network interface device 408. Computer system 400 may also include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

Data storage device 418 may include a machine-readable storage medium (or more specifically a computer-readable storage medium) 420 having one or more sets of instructions (e.g., OS layer manager 110) embodying any one or more of the methodologies of functions described herein. The OS layer manager 110 may also reside, completely or at least partially, within main memory 404 and/or within processing device 402 during execution thereof by computer system 400; main memory 404 and processing device 402 also constituting machine-readable storage media. OS layer manager 110 may further be transmitted or received over a network 426 via network interface device 408.

Machine-readable storage medium 420 may also be used to store the device queue manner logic persistently. While machine readable storage medium 420 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instruction for execution by the machine and that causes the machine to perform any one or more of the methodologies of the present disclosure. The term “machine-readable storage medium” shall accordingly be taken to include, but not limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of methods and symbolic representations of operations on data bits within a computer memory. These descriptions and representations are the means used by those skilled in the data processing arts to most effectively convey the substance of their work to others skilled in the art. A method is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling,” “transmitting,” “requesting,” “identifying,” “querying,” “retrieving,” “forwarding,” “determining,” “passing,” “processing,” “issuing,” “measuring,” “caching,” “monitoring,” mapping,” “estimating,” “calculating,” “disabling,” “detecting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), erasable programmable ROMs (EPROMs), electrically erasable programmable ROMs (EEPROMs), magnetic or optical cards, flash memory devices including universal serial bus (USB) storage devices (e.g., USB key drives) or any type of media suitable for storing electronic instructions, each of which may be coupled to a computer system bus.

The methods and illustrative examples described herein are not inherently related to any particular computer or other apparatus. Various general purpose systems may be used with programs in accordance with the teachings herein or it may prove convenient to construct more specialized apparatus to perform the required method 300, and/or each of their individual functions, routines, subroutines or operations. Examples of the structure for a variety of these systems are set forth in the description above.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
identifying a plurality of functionalities available to a device, wherein the device comprises a base operating system, wherein each functionality is associated with a corresponding operating system layer;
detecting a triggering event associated with a functionality of the plurality of functionalities; and
responsive to detecting the triggering event, adding, to the base operating system, the operating system layer corresponding to the functionality.

2. The method of claim 1, further comprising:
receiving a user identifier;
identifying, in an end-user operating system layer registry, an end-user operating system layer associated with the user identifier, wherein the end-user operating system layer comprises one or more configuration files associated with the user identifier; and
installing the end-user operating system layer over the base operating system.

3. The method of claim 1, further comprising:
responsive to detecting a second triggering event associated with a second functionality of the plurality of functionalities, adding, to the base operating system, a second operating system layer corresponding to the second functionality;
determining a first priority level associated with the functionality;
determining a second priority level associated with the second functionality; and
responsive to determining that the second priority level exceeds the first priority level, prioritizing the second operating system layer over the operating system layer.

4. The method of claim 3, wherein determining the first priority level comprises at least one of: identifying, in an OS layer registry, the first priority level of the operating system layer corresponding to the functionality; or determining the first priority level associated with the functionality based on an amount of resources consumed by the functionality.

5. The method of claim 1, further comprising:
responsive to determining that the functionality is no longer needed, removing the operating system layer corresponding to the functionality.

6. The method of claim 5, wherein determining that the functionality is no longer needed comprises at least one of: detecting a second triggering event associated with turning off the functionality, or determining that an amount of resources consumed by the functionality has decreased by at least a predetermined percentage.

7. The method of claim 1, wherein the triggering event comprises at least one of a user request, a usage condition threshold, an expiration of a specified time period, or detection of a presence of a second device.

8. A system comprising:
a memory; and
a processing device operatively coupled to the memory, the processing device to:
identify a plurality of functionalities available to a device, wherein the device comprises a base operating system, wherein each functionality is associated with a corresponding operating system layer;
detect a triggering event associated with a functionality of the plurality of functionalities; and
responsive to detecting the triggering event, add, to the base operating system, the operating system layer corresponding to the functionality.

9. The system of claim 8, wherein the processing device is further to:
receive a user identifier;
identify, in an end-user operating system layer registry, an end-user operating system layer associated with the user identifier, wherein the end-user operating system layer comprises one or more configuration files associated with the user identifier; and
install the end-user operating system layer over the base operating system.

10. The system of claim 8, wherein the processing device is further to:
responsive to detecting a second triggering event associated with a second functionality of the plurality of functionalities, add, to the base operating system, a second operating system layer corresponding to the second functionality;
determine a first priority level associated with the functionality;
determine a second priority level associated with the second functionality; and
responsive to determining that the second priority level exceeds the first priority level, prioritize the second operating system layer over the operating system layer.

11. The system of claim 10, wherein to determine the first priority level comprises at least one of: identifying, in an OS layer registry, the first priority level of the operating system layer corresponding to the functionality; or determining the first priority level associated with the functionality based on an amount of resources consumed by the functionality.

12. The system of claim 8, wherein the processing device is further to:
responsive to determining that the functionality is no longer needed, remove the operating system layer corresponding to the functionality.

13. The system of claim 12, wherein to determine that the functionality is no longer needed comprises at least one of: detecting a second triggering event associated with turning off the functionality, or determining that an amount of resources consumed by the functionality has decreased by at least a predetermined percentage.

14. A non-transitory computer-readable media storing instructions that, when executed, cause a processing device to perform operations comprising:
identifying a plurality of functionalities available to a device, wherein the device comprises a base operating system, wherein each functionality is associated with a corresponding operating system layer;
detecting a triggering event associated with a functionality of the plurality of functionalities; and
responsive to detecting the triggering event, adding, to the base operating system, the operating system layer corresponding to the functionality.

15. The non-transitory computer-readable media of claim 14, further comprising:
receiving a user identifier;
identifying, in an end-user operating system layer registry, an end-user operating system layer associated with the user identifier, wherein the end-user operating system layer comprises one or more configuration files associated with the user identifier; and
installing the end-user operating system layer over the base operating system.

16. The non-transitory computer-readable media of claim 14, further comprising:
responsive to detecting a second triggering event associated with a second functionality of the plurality of functionalities, adding, to the base operating system, a second operating system layer corresponding to the second functionality;
determining a first priority level associated with the functionality;
determining a second priority level associated with the second functionality; and
responsive to determining that the second priority level exceeds the first priority level, prioritizing the second operating system layer over the operating system layer.

17. The non-transitory computer-readable media of claim 16, wherein determining the first priority level comprises at least one of: identifying, in an OS layer registry, the first priority level of the operating system layer corresponding to the functionality; or determining the first priority level associated with the functionality based on an amount of resources consumed by the functionality.

18. The non-transitory computer-readable media of claim 14, further comprising:
responsive to determining that the functionality is no longer needed, removing the operating system layer corresponding to the functionality.

19. The non-transitory computer-readable media of claim 18, wherein determining that the functionality is no longer needed comprises at least one of: detecting a second triggering event associated with turning off the functionality, or determining that an amount of resources consumed by the functionality has decreased by at least a predetermined percentage.

20. The non-transitory computer-readable media of claim 14, wherein the triggering event comprises at least one of a user request, a usage condition threshold, an expiration of a specified time period, or detection of a presence of a second device.
